(19) United States
(12) Patent Application Publication
(10) Pub. No.: US 2008/0291119 A1
(43) Pub. Date: Nov. 27, 2008

(54) PC image distributing facility

(75) Inventors: Koichi Hida, Osaka (JP); Michimasa Hasegawa, Osaka (JP)

Correspondence Address: FILDES & OUTLAND, P.C., 20916 MACK AVENUE, SUITE 2, GROSSE POINTE WOODS, MI, 48236, US

(73) Assignee: CONTEC CO., LTD.

(21) Appl. No.: 12/154,028

(22) Filed: May 20, 2008

(30) Foreign Application Priority Data
May 24, 2007 (JP) 2007-137312

(51) Int. Cl. G09G 5/00

(52) U.S. Cl. 345/1.3

(57) ABSTRACT

A PC image distributing facility according to the present invention includes a transmitter 3 connected to a PC 1 and a LAN cable 8 to convert display image data output by the PC 1 into a LAN packet and then output the LAN packet to the LAN cable 8. The PC image distributing facility further includes a receiver 5 for each display 6 in a corresponding PC image display area 4. The receiver 5 is connected to the LAN cable 8 and the display 6 to convert the LAN packet input by the transmitter 3 via the LAN cable 8 into analog image data and then output the analog image data to the display 6.

### FIELD OF THE INVENTION

The present invention relates to a PC image distributing facility that distributes images formed by one PC (Personal Computer) to at least one remote display (monitor) for displaying the images.

### BACKGROUND OF THE INVENTION

One known PC image distributing facility is a video conferencing system disclosed in, for example, Japanese Patent Laid-Open No. 2000-23128. The vide conferencing system comprises one PC that stores a plurality of image data and to which a monitor (liquid crystal display) is connected, and a plurality of display devices each composed of a monitor and a touch panel. The PC is connected to the plurality of display devices by distributors.

The PC has an image memory that stores image data for an initial screen, image data (textual or graphic data) for the contents of presentations pre-input by a plurality of conference presenters, and value-added image data (for example, image data indicating the results of “votes”) to be added to the image data, a CPU that selects any of the plurality of image data stored in the image memory, and an image controller that outputs the image data selected in accordance with an instruction from the CPU. Transmission software is installed in the PC to actually transmit the image data. When the touch panel of any display device is operated to select any of the image data in the PC, the PC transmits the selected image data in the PC to each of the display devices to display the image data on all the monitors.

However, to actually transmit the image data, the configuration of the known PC image distributing facility requires the installation of the transmission software and complicated settings. Disadvantageously, an OS compatible with the transmission software is limited, and an available PC is thus limited. Furthermore, in transmitting the image data, the PC executes software processing in order to transmit the corresponding images. Thus, disadvantageously, the CPU needs to bear a burden and suffers a decrease in processing speed.

### Disclosure of the Invention

Thus, the present invention solves the above-described problems. An object of the present invention is to provide a PC image distributing facility which eliminates the need to install software required to transmit and receive images in a PC and which can thus distribute image data (display image data) output by the PC to at least one remote display, regardless of an operating environment and without imposing a burden on a CPU.

To accomplish the object, the present invention provides a PC image distributing facility allowing image data output by a PC to be displayed on at least one display via a cable, the facility including a transmitter connected to the PC and the cable to convert the image data output by the PC into a data transfer packet and then output the data transfer packet to the cable, and a receiver for each display which is connected to the cable and the display to convert the data transfer packet input by the transmitter via the cable into image data and then output the image data to the display.

With this configuration, simply by connecting the transmitter to the PC, the transmitter to the cable, the receiver to the cable, and the display to the receiver, it is possible to display the image data output by the PC on at least one display connected to the cable. The configuration also eliminates the need to install and set the software required to transmit the image data to the PC. This in turn eliminates the need to take into account the operating environment of the PC when the facility is constructed. Moreover, when an image is displayed on at least one display, the transmitter executes a process of transmitting the image data, whereas the PC (CPU) does not execute the transmitting process. The PC is thus prevented from bearing a burden and from suffering a decrease in processing speed.

### BRIEF DESCRIPTION OF THE DRAWINGS

FIG. 1 is a diagram of the configuration of a PC image distributing facility according to an embodiment of the present invention;

FIG. 2 is a perspective view of the external shape of a transmitter in the PC image distributing facility;

FIG. 3 is a block diagram illustrating the control of the transmitter in the PC image distributing facility;

FIG. 4 is a flowchart of an FPGA in the transmitter in the PC image distributing facility;

FIG. 5 is a perspective view of the external shape of a receiver in the PC image distributing facility;

FIG. 6 is a block diagram illustrating the control of the receiver in the PC image distributing facility;

FIG. 7 is a flowchart of an FPGA in the receiver in the PC image distributing facility;

FIG. 8 is a diagram of the configuration of a PC image distributing facility according to another embodiment of the present invention;

FIG. 9 is a perspective view of the external shape of a receiver according to another embodiment of the present invention; and

FIG. 10 is a diagram showing how the receiver in FIG. 9 is mounted on a display.

### DESCRIPTION OF THE EMBODIMENTS

Embodiments of the present invention will be described with reference to the drawings.

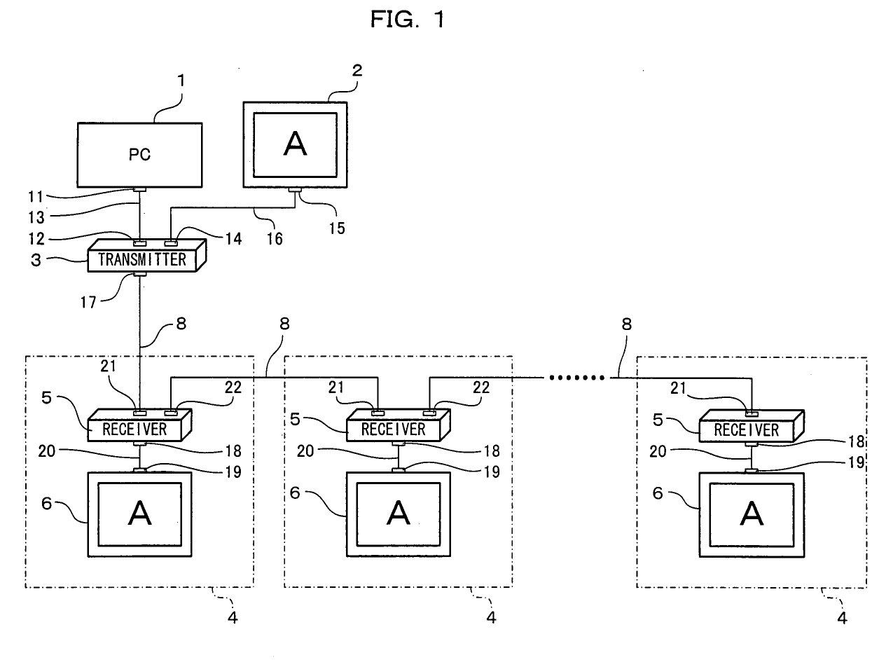

FIG. 1 is a diagram of the configuration of a PC image distributing facility according to an embodiment of the present invention.

A PC 1 that distributes images, a display 2 for the PC 1, and a transmitter 3 are arranged as PC image transmitting apparatuses. A receiver 5 with a built-in HUB function and a display 6 are arranged in each PC image display area 4 as PC image receiving apparatuses. The transmitter 3 and the receivers 5 in the respective PC image display areas 4 are connected together in daisy chain form by a LAN cable 8. A unique multicast address is assigned to each of the transmitter 3 and the receivers 5.

Connections on the PC image transmitting side are as described below.

A video connector (VGA (Video Graphics Array) connector or DVI (Digital Visual Interface) connector; display output connector) 11 of the PC 1 and a VGA connector 12 (or DVI connector 38) of the transmitter 3 are connected together by a cable (for example, a VGA cable) 13. A monitor connector (VGA connector or DVI connector) 14 of the transmitter 3 is connected to a monitor connector (VGA connector or DVI connector) 15 of the display 2 by a cable (for example, a VGA cable) 16. The LAN cable 8 is connected to a LAN connector 17 of the transmitter 3.

Connections on the PC image receiving side are as described below.

In each of the PC image display areas 4, a monitor connector (VGA connector) 18 (or a DVI connector 57) of the receiver 5 and a monitor connector (VGA connector or DVI connector) 19 of the display 6 are connected together by a cable (for example, a VGA cable) 20. The LAN cable 8 is connected to a first LAN connector 21 and a second LAN connector 22 of the receiver 5.

### [Transmitter 3]

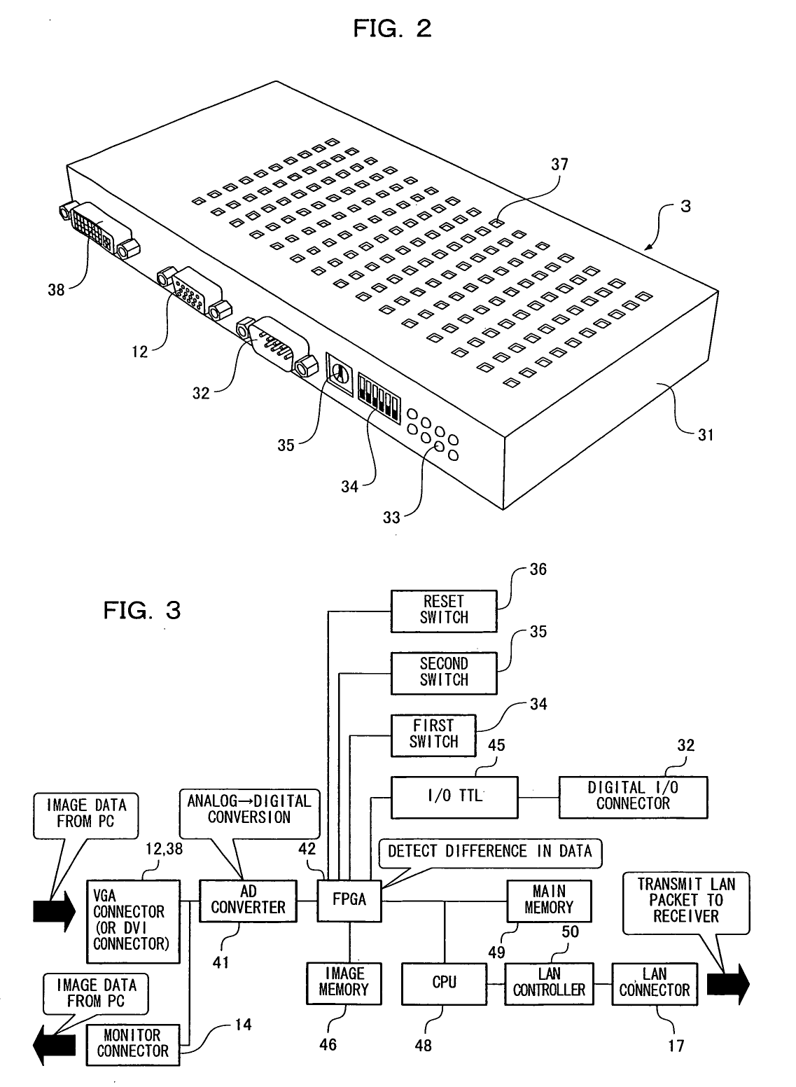

The transmitter 3 will be described in detail with reference to a perspective view in FIG. 2 showing the appearance of the transmitter 3 and a block diagram in FIG. 3.

In FIG. 2, reference numeral 31 denotes a box-like case including a built-in substrate having functions shown in the block diagram in FIG. 3. The case 31 has, on a top surface thereof, the VGA connector 12, the DVI connector 38, a digital I/O connector 32, eight LED lamps 33, a first switch 34 made up of six piano switches, and a second switch (an example of a setting switch) 35 made up of a rotary switch that can be selectively placed in any one of 16 positions. The position of the second switch 35 corresponds to an address for multicast transfer (corresponding to a group address). The LED lamps 33 display the status of a power source, the status of communication through the LAN port, the status of data transmission, and the like. The first switch 34 is used, for example, to initialize an image memory described below, to suspend data transmission, and to switch to a maintenance mode.

The case 31 has, on a bottom surface thereof, the monitor connector 14, the LAN connector 17, and an initialization (reset) switch 36 (FIG. 3) made up of a pushbutton switch. A plurality of holes 37 are formed in a front surface and a rear surface of the case 31 to release heat generated in the case 31.

As shown in FIG. 3, the monitor connector 14 and an AD converter 41 are connected to the VGA connector 12 (or DVI connector 38); the AD converter 41 converts analog image data into digital image data. An FPGA (Field Programmable Gate Array) 42 (the functions of the FPGA will be described below; advantageously, logics can be optionally written to the FPGA) is connected to the AD converter 41. The first switch 34, the second switch 35, and the initialization (reset) switch 36 are connected to the FPGA 42. The digital I/O connector 32 is connected to the FPGA 42 via an I/O TTL 45. An image memory 46 is also provided which has two areas in each of which image data for one screen can be stored at the same addresses. The image memory 46 is connected to the FPGA 42.

A CPU 48 and a main memory 49 for the CPU 48 are connected to the FPGA 42. A LAN controller 50 is connected to the CPU 48. The LAN connector 17 is connected to the LAN controller 50.

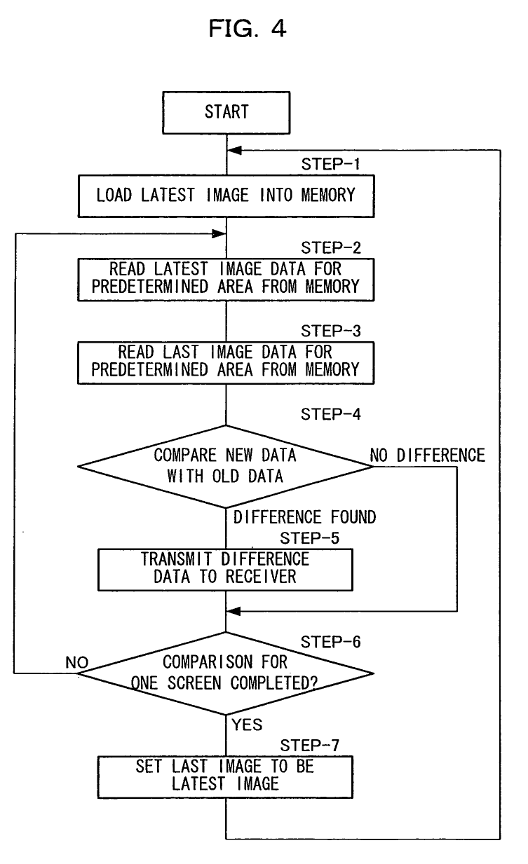

The functions of the FPGA 42 will be described with reference to a flowchart in FIG. 4. It is assumed that in an initial state, no image data is stored in the image memory 46 (data-deleted state). Turning on the power source starts distribution. When loaded into the transmitter 3, analog image data output by the PC 1 is converted into digital image data by the AD converter 41. The digital image data is then loaded into the FPGA 42.

When powered on, the transmitter 3 first loads image data for the latest screen into one of the areas of the image memory 46 as the latest image data (step-1). Then, image data for one LAN packet unit (an example of a data transfer packet) is read from the latest image data stored in the image memory 46 (step-2). From the last image data stored in the other area of the image memory 46, image data for one LAN packet unit located at the same address as that of the image data from the latest image data is read (step-3). Both image data are checked for a difference (step-4). In step-4, when a difference is found between the two pieces of image data, an address for the LAN packet unit on the screen and a multicast address set via the second switch 35 are assigned to the difference data (or the difference data is compressed before the addresses are assigned to the difference data). The difference data is then output to the LAN controller 50 (step-5). Subsequently or when no difference is found in step-4, it is determined whether or not a check for a difference of the image data for each LAN packet unit has been completed for one screen (step-6). If step 6 determines that the check has not been completed for one screen, the process returns to step-2 to read the next image data for one LAN packet unit from the latest image data to check for a difference. If step-6 determines that the check has been completed for one screen, the latest image data stored in the image memory 46 is set to be the last image data (step-7). The process then returns to step-1. For the image data for the initial screen, the image memory 46 contains no image data to be compared. The image data is thus directly output as difference data.

Then, the LAN controller 50 outputs, as a LAN packet, the difference image data to which the screen address for the LAN packet unit and the multicast address are assigned.

Thus, the transmitter 3 converts the display image data (the image data output by the PC 1) directly loaded via the video connector 11 of the PC 1, into the LAN packets by the FPGA 42, and outputs the LAN packets to the LAN cable 8.

### [Receiver 5]

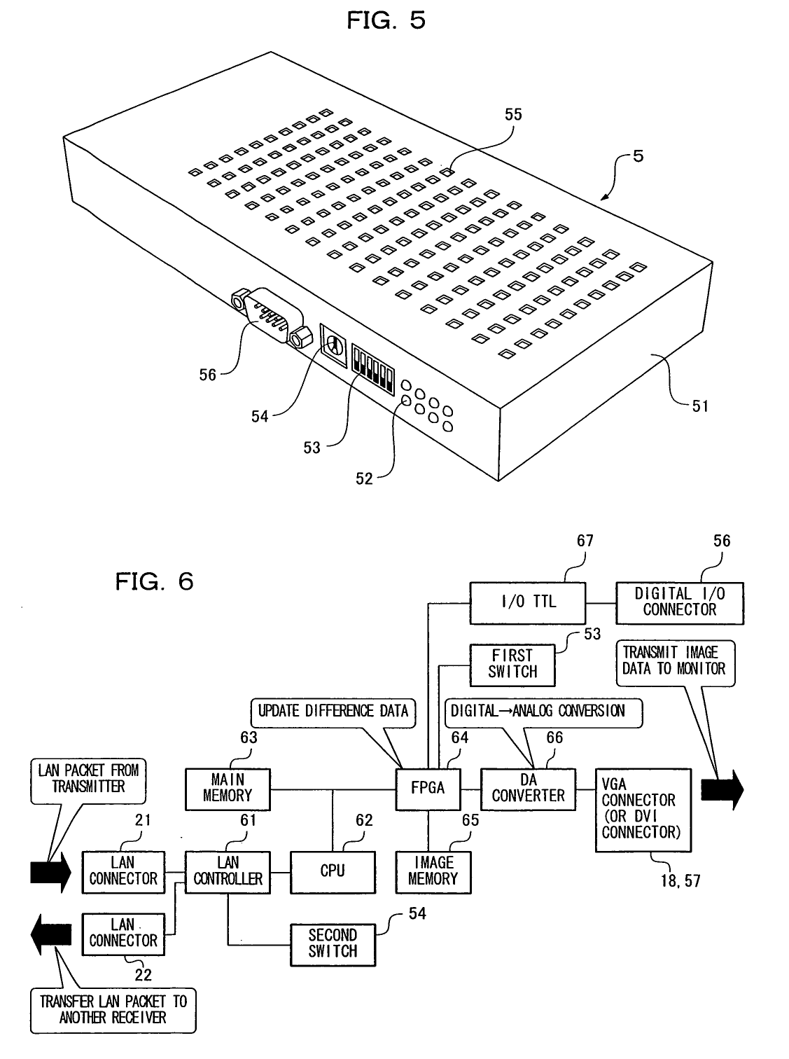

The receiver 5 will be described in detail with reference to a perspective view in FIG. 5 showing the appearance of the receiver 5 and a block diagram in FIG. 6.

In FIG. 5, reference numeral 51 denotes a box-like case including a built-in substrate having functions shown in the block diagram in FIG. 6. The case 51 has, on a top surface thereof, a digital I/O connector 56, eight LED lamps 52, a first switch 53 made up of six piano switches, and a second switch (an example of a setting switch) 54 made up of a rotary switch that can be selectively placed in any one of 16 positions. The position of the second switch 54 allows a multicast address to be set for the receiver 5. The LED lamps 52 display the status of the power source, the status of communication through the LAN port, the status of data reception, and the like. The first switch 53 is used, for example, to initialize an image memory described below and to switch to the maintenance mode.

When the multicast address set via the second switch 35 of the transmitter 3 matches the multicast address set via the second switch 54 of the receiver 5, the receiver 5 receives the display image data transmitted from the PC 1 by the transmitter 3. When the second switch 35 of the transmitter 3 and the second switch 54 of the receiver 5 are used to set, for example, “0” for the transmitter 3 and all the receivers 5, the transmitter 3 concurrently distributes the display image data from the PC 1 to all the receivers 5. When for example, “1” is set for the transmitter 3 and only the first and second receivers 5 (“a value other than 1” is set for the other receivers 5), the transmitter 3 distributes the display image data only to the first and second receivers 5.

The case 51 has, on a bottom surface thereof, the monitor connector 18, the LAN connectors 21 and 22, and a DVI connector 57 (FIG. 6). A plurality of holes 55 are formed in a front surface and a rear surface of the case 51 to release heat generated in the case.

As shown in FIG. 6, a LAN controller 61 is connected to the first LAN connector 21. The second LAN connector 22, the second switch 54, and a CPU 62 are connected to the LAN controller 61. The CPU 62 connects to a main memory 63 for the CPU 62 and an FPGA (Field Programmable Gate Array) 64 (the functions of the FPGA will be described below; advantageously, logics can be optionally written to the FPGA). The FPGA 64 connects to the first switch 53, an image memory 65 that can store image data for one screen, and a DA converter 66 that converts digital image data into analog image data. The digital I/O connector 56 is connected to the FPGA 64 via an I/O TTL 67. The monitor connector 18 or the DVI connector 57 is connected to the DA converter 66.

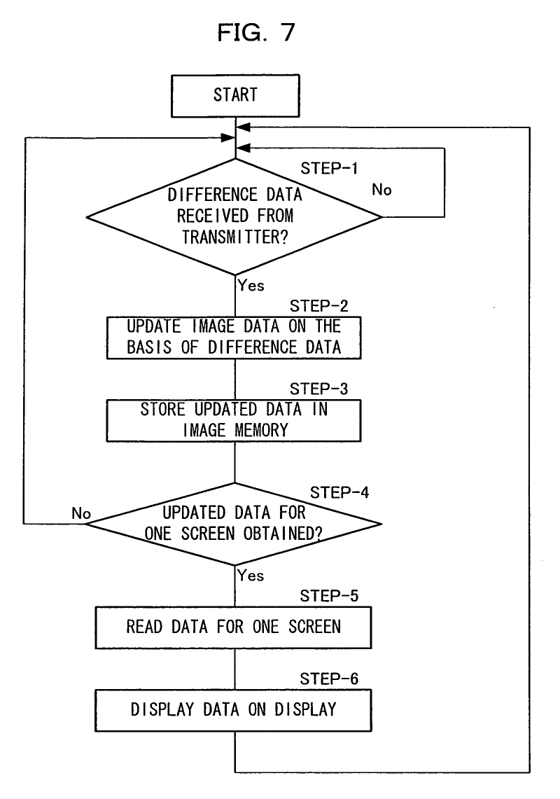

The functions of the FPGA 64 will be described with reference to a flowchart in FIG. 7. It is assumed that in the initial state, no image data is stored in the image memory 65 (data-deleted state). The LAN controller 61 determines whether or not the input LAN packet has been transmitted to the address of the LAN controller 61 by checking whether or not the multicast address set via the second switch 54 matches the multicast address attached to the LAN packet. Upon determining that the input LAN packet has been transmitted to the address of the LAN controller 61, the LAN controller 61 allows the input of the difference image data in the LAN packet unit with the address.

When the difference image data for one LAN packet unit with the address from the transmitter 3 is input to the LAN controller 61 (step-1), the LAN controller 61 uses the difference image data to update a part of the last image data stored in the image memory 65 which part has the same address as that of the LAN packet unit (step-2). The updated image data is re-stored in the image memory 65 (step-3). The LAN controller 61 subsequently determines whether or not reception of the difference image data has been completed for one screen (step-4). If step-4 determines that the reception of the difference image data has not been completed for one screen, the process returns to step-1. With the initial difference data, the image data (free from a difference) is directly transmitted to the LAN controller 61, and no image data is stored in the image memory 65 (data-deleted state). The transmitted image data (free from a difference) is directly stored in the image memory 65.

When the reception of the difference image data is completed for one screen, the image data for the screen stored in the image memory 65 is read (step-5). The image data is output to the DA converter 66 (step-6). The process returns to step-1.

The DA converter 66 outputs the image data for one screen to the display 6 for displaying the image data.

Thus, the receiver 5 uses the FPGA 64 to convert the LAN packet input by the transmitter 3 via the LAN cable 8, into analog image data. The receiver 5 then outputs the analog image data to the display 6.

The effects of the above-described configuration will be described.

The display 6 is installed in the PC image display area 4. The receiver 5 is connected to the already laid LAN cable 8. The receiver 5 and the display 6 are then connected together via the cable 20. Then, the second switch 54 of the receiver 5 is used to set a multicast address for each of the receivers 5.

The transmitter 3 is connected to the LAN cable 8. The PC 1 is connected to the transmitter 3 via the cable 13. The display 2 for the PC 1 is connected to the transmitter 3 via the cable 16. The second switch 35 of the transmitter 3 is used to set a multicast address, that is, the PC image display area 4 (receiver 5) to which the image output by the PC 1 is to be transmitted.

After the connections and the settings are thus performed, a normal operation is performed to allow the display 2 for the PC 1 to display the image to be distributed. The transmitter 3 is further powered on. Then, the image to be displayed on the display 2 for the PC 1 is loaded into the transmitter 3 and then output to and displayed on the display 2 for the PC 1. The image is also transmitted to the PC image display area 4 (receiver 5) selected via the second switch 35 of the transmitter 3. The same image as that displayed on the display 2 for the PC 1 is shown on (distributed to) the display 6 in the PC image display area 4. At this time, as described above, the image is distributed to the receiver 5 for which the same multicast address as that set for the transmitter 3 is set. Thus, the hardware (transmitter 3) located outside the PC 1 distributes the image data, preventing a burden from being imposed on the PC 1.

Furthermore, at this time, except for the initial image data, the difference data on the image is determined and transmitted (or compressed and then transmitted) to reduce the amount of data transmitted between the transmitter 3 and the receiver 5. Image update rate increases and the image is almost synchronously shown on the displays, thus realizing real-time image display.

As described above, according to the present embodiment, simply by connecting the transmitter 3 to the video connector 11 of the PC 1, the LAN connector 17 of the transmitter 3 to the LAN cable 8, the LAN connectors 21 and 22 of the receiver 5 to the LAN cable 8, each display 6 to the corresponding receiver 5, and each apparatus to the corresponding power source, at the site of the facility, it is possible to show the display image output by the PC 1 on the plurality of displays 6 via the LAN without the need to install transmission software required to transmit the image data to the PC 1 and without the need to make any setting (however, the second switch 35 of the transmitter 3 and the second switch 54 of each receiver 5 need to be set to be compatible with the facility before shipment). Thus, it is unnecessary to install and set the transmission software in the PC 1 and to have the software. This makes it possible to eliminate the need to select the operating environment. Furthermore, the PC 1 does not execute the process of transmitting images. Consequently, the PC 1 can allow the image to be shown on the plurality of remote displays 6 located away from the PC 1 without imposing a burden on the PC 1 (CPU) and without the need to take a distribution distance into account. Moreover, by converting the analog image data into the digital LAN packet and outputting the LAN packet, it is possible to increase the distance between the PC 1 and the display 6 to about 100 m; with the conventional technique, the distance could be increased up to about 5 m. The use of a daisy chain function enables an unlimited increase in distance as well as the connection of an unlimited number of displays 6; with the conventional technique, the number of the displays is limited to one.

Furthermore, the present embodiment allows the image to be selectively displayed on the display 6 in the PC image display area 4 selected via the second switch (rotary switch) 35 provided on the transmitter 3. Additionally, the image can be concurrently displayed on (concurrently distributed to) the displays 6 in all the PC image display areas 4.

Furthermore, according to the present embodiment, the transmitter 3 determines and transmits (or compresses and then transmits) the difference data corresponding to only the changed part of the image data to enable a reduction in the amount of data transmitted between the transmitter 3 and the receiver 5. The receiver 5 uses the difference data to update the image data to enable an increase in image update rate, thus allowing real-time display to be realized.

In the present embodiment, the single PC 1 distributes the image to the plurality of displays 6 arranged in the respective PC image display areas 4. However, the facility may be such that the single PC 1 distributes the image to only one display 6 located in the single PC image display area 4.

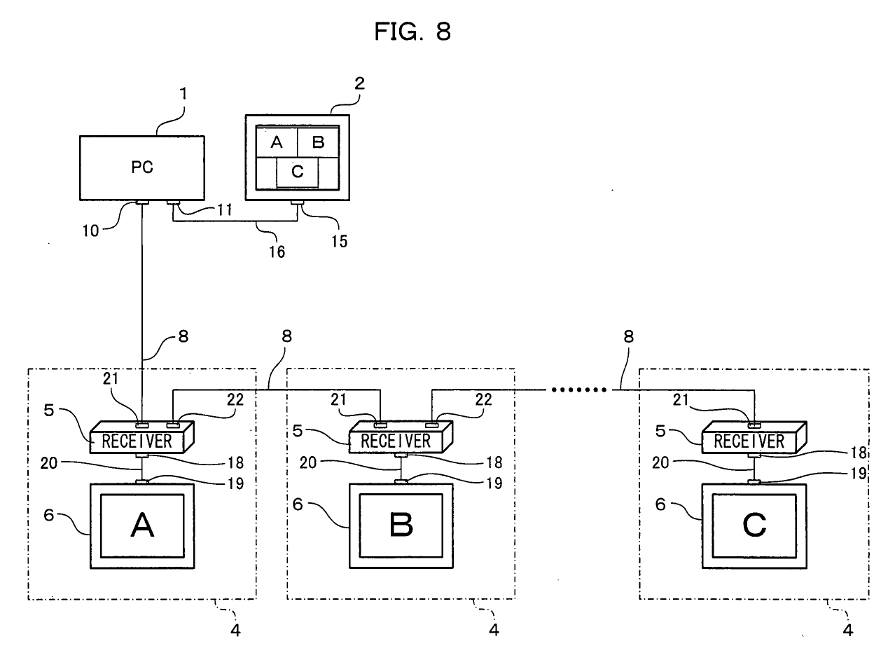

Furthermore, in the present embodiment, the image output to the display 2 for the PC 1 is directly shown on the display 6 in the PC image display area 4. However, as shown in FIG. 8, the PC 1 can separate the plurality of images output to the display 2 for the PC 1 from one another (or separate the images from one another and enlarge each of the images) and output the separate images through the LAN connector 10 so that the displays 6 in the respective PC image display areas 4 display the different images. In this case, the PC 1 has the FPGA and the LAN controller, and the PC image display areas 4 are set to each of which the corresponding image and an address on the screen occupied by the image are sent. The difference image data for one LAN packet unit is created. Then, checks are made on the address for the LAN packet unit and on settings for the PC image display area 4 to which the corresponding image and the address on the screen occupied by the image are sent. A set multicast address is assigned to the difference image data, which is then output.

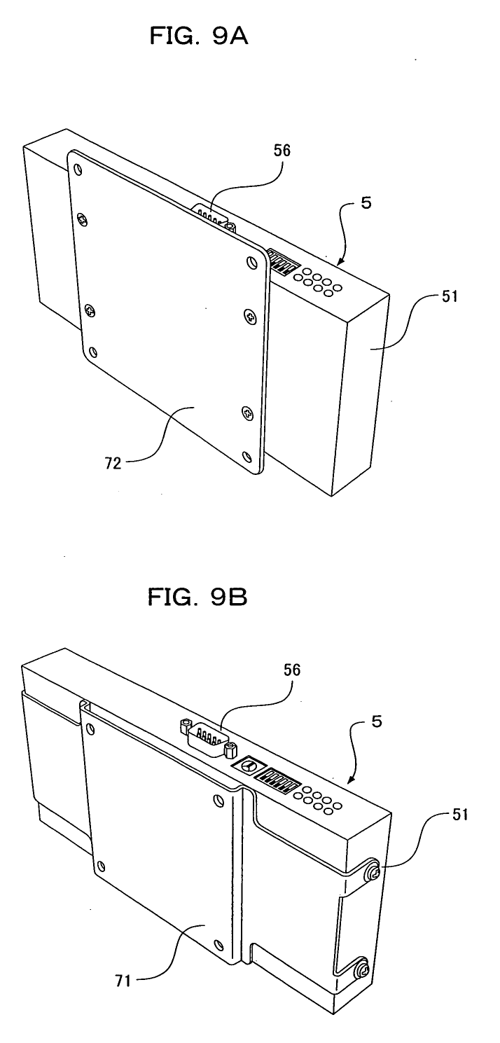

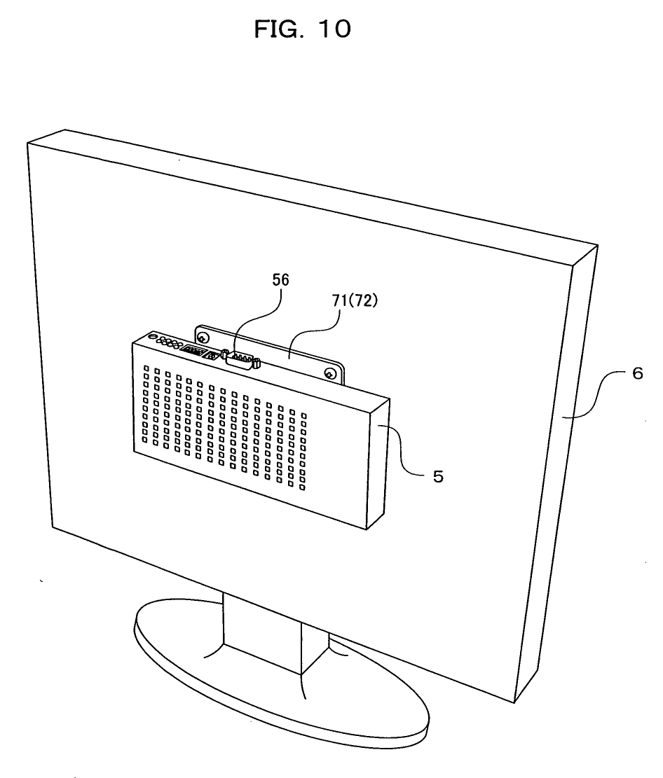

Furthermore, in the present embodiment, the receiver 5 is located immediately below the display. However, it is possible to attach a bracket (conforming to the VESA (Video Electronics Standards Association) standards 75 mm-pitch four-point (75×75)) 71 or a bracket (conforming to the VESA standards 100 mm-pitch four-point (100×100)) 72 to the receiver 5 as shown in FIG. 9 and to mount the receiver 5 directly on the display 6 conforming to the VESA standards, via the bracket 71 or 72 (for example, using screws) as shown in FIG. 10. Thus providing the bracket 71 or 72 makes it possible to save space.

In the present embodiment, the transmitter 3 transmits only the display image data from the PC 1 to the receivers 5. However, digital data input through the digital I/O connector 32, for example, on/off data on a switch connected to the digital I/O connector 32, can be attached to the display image data for transmission to the receivers 5. Consequently, each of the receivers 5 can execute a sequence on the basis of the received digital data. For example, a lamp can be connected to the digital I/O connector 56 of the receiver 5 so as to be turned on and off by the FPGA 64 via the I/O TTL 67 and the digital I/O connector 56 in accordance with the input on/off data on the switch.

Furthermore, in the present embodiment, the plurality of receivers 5 are connected together in daisy chain mode. However, the receivers 5 can be connected together in star form using a common LAN hub.

Additionally, in the present embodiment, the PC 1 distributes the image to the receivers 5 connected to the LAN cable 8. However, the PC 1 can distribute the image to the receiver 5 connected to the Internet beyond the LAN. In this case, a MAC address or unicast of the receiver 5 connected to the Internet is assigned to one of the positions of the second switch 35 of the transmitter 3. To distribute the image to the receiver 5 connected to the Internet, the second switch 35 is set in the position to which the MAC address or unicast is assigned.

What is claimed is:

1. A PC image distributing facility allowing image data output by a PC to be displayed on at least one display via a cable, the facility comprising:
a transmitter connected to the PC and the cable to convert the image data output by the PC into a data transfer packet and then output the data transfer packet to the cable; and
a receiver for each display which is connected to the cable and the display to convert the data transfer packet input by the transmitter via the cable into image data and then output the image data to the display.

2. The PC image distributing facility according to claim 1, wherein the transmitter has a setting switch on which an address of the receiver or receiver group displaying the image data output by the PC is set, and
the receiver has a setting switch used to set an address at which the image data transmitted by the transmitter is received.

3. The PC image distributing facility according to claim 1, wherein the transmitter has an FPGA converting the image data output by the PC into the data transfer packet, and
the receiver has an FPGA converting the data transfer packet input by the transmitter via the cable into the image data.

4. The PC image distributing facility according to claim 1, wherein the transmitter has:
an image memory having two areas each capable of storing the image data for one screen at the same addresses; and
an FPGA storing the image data output by the PC in one of the two areas of the image memory and determining difference data for each address in the two areas of the image memory, the difference data indicating a difference between the image data stored in the one of the two areas of the image memory and the last image data stored in the other area of the image memory, the FPGA then converting the difference data into the data transfer packet and outputting the data transfer packet, and
the receiver has:
an image memory capable of storing the image data for one screen; and
an FPGA which, when the transmitter inputs the data transfer packet to the receiver via the cable, updates the image data in the image memory using the difference data in the data transfer packet and then outputs the updated image data.

5. The PC image distributing facility according to claim 1, wherein the transmitter has:
a digital input connector; and
an FPGA converting the image data output by the PC into the data transfer packet, attaching digital data input through the digital input connector to the data transfer packet, and then outputting the resulting data transfer packet, and
the receiver has:
a digital output connector; and
an FPGA converting and outputting the data transfer packet input by the transmitter via the cable and outputting the digital data attached to the data transfer packet to the digital output connector.

6. The PC image distributing facility according to claim 1, wherein the receiver has a mounting bracket used to fix the receiver to a rear surface of the display.

7. The PC image distributing facility according to claim 2, wherein the transmitter has an FPGA converting the image data output by the PC into the data transfer packet, and
the receiver has an FPGA converting the data transfer packet input by the transmitter via the cable into the image data.

8. The PC image distributing facility according to claim 2, wherein the transmitter has:
an image memory having two areas each capable of storing the image data for one screen at the same addresses; and
an FPGA storing the image data output by the PC in one of the two areas of the image memory and determining difference data for each address in the two areas of the image memory, the difference data indicating a difference between the image data stored in the one of the two areas of the image memory and the last image data stored in the other area of the image memory, the FPGA then converting the difference data into the data transfer packet and outputting the data transfer packet, and
the receiver has:
an image memory capable of storing the image data for one screen; and
an FPGA which, when the transmitter inputs the data transfer packet to the receiver via the cable, updates the image data in the image memory using the difference data in the data transfer packet and then outputs the updated image data.

9. The PC image distributing facility according to claim 2, wherein the transmitter has:
a digital input connector; and
an FPGA converting the image data output by the PC into the data transfer packet, attaching digital data input through the digital input connector to the data transfer packet, and then outputting the resulting data transfer packet, and
the receiver has:
a digital output connector; and
an FPGA converting and outputting the data transfer packet input by the transmitter via the cable and outputting the digital data attached to the data transfer packet to the digital output connector.

10. The PC image distributing facility according to claim 2, wherein the receiver has a mounting bracket used to fix the receiver to a rear surface of the display.

11. The PC image distributing facility according to claim 3, wherein the receiver has a mounting bracket used to fix the receiver to a rear surface of the display.

12. The PC image distributing facility according to claim 4, wherein the receiver has a mounting bracket used to fix the receiver to a rear surface of the display.

13. The PC image distributing facility according to claim 5, wherein the receiver has a mounting bracket used to fix the receiver to a rear surface of the display.

14. The PC image distributing facility according to claim 7, wherein the receiver has a mounting bracket used to fix the receiver to a rear surface of the display.

15. The PC image distributing facility according to claim 8, wherein the receiver has a mounting bracket used to fix the receiver to a rear surface of the display.

16. The PC image distributing facility according to claim 9, wherein the receiver has a mounting bracket used to fix the receiver to a rear surface of the display.
